(19) United States
(12) Patent Application Publication
(10) Pub. No.: US 2014/0328941 A1
(43) Pub. Date: Nov. 6, 2014

(54) NON-CORROSIVE STABLE PERACETIC ACID CONCENTRATE SOLUTION

(71) Applicant: Medivators Inc., Minneapolis, MN (US)

(72) Inventors: Huyen Phuong Bui, Brooklyn Park, MN (US); John J. Matta, Shoreview, MN (US); Tuan Nguyen, Chaska, MN (US); Thomas M. Gentle, St. Michael, MN (US)

(21) Appl. No.: 14/366,298

(22) PCT Filed: Dec. 21, 2012
(86) PCT No.: PCT/US2012/071333

§ 371 Date: Jun. 18, 2014

Related U.S. Application Data
(60) Provisional application No. 61/579,459, filed on Dec. 22, 2011.

(51) Int. Cl. A01N 25/30; B65D 77/24; B65D 81/18; A01N 59/00; A01N 37/02

(52) U.S. Cl. CPC A01N 25/30; A01N 59/00; A01N 37/02; B65D 81/18; B65D 77/245; B65D 2203/04; B65D 2203/02; B65D 2205/00
USPC 424/616; 206/459.5; 206/229

(57) ABSTRACT

A composition that includes: (a) hydrogen peroxide; (b) at least one of an inorganic acid and an organic acid; (c) chelator; (d) anticorrosive agent; and (e) surfactant. Kits that include the composition, as well as methods of using the composition (e.g., as a disinfectant) are provided.

### CLAIM OF PRIORITY

This application claims the benefit of priority of U.S. Provisional Patent Application Ser. No. 61/579,459, filed Dec. 22, 2011, titled “NON-CORROSIVE STABLE PERACETIC ACID CONCENTRATE SOLUTION,” the entire disclosure of which is incorporated by reference as if fully set forth herein.

### BACKGROUND OF THE INVENTION

A perfect disinfectant would offer complete and full microbiological sterilization, without harming humans and useful forms of life, be inexpensive, and non-corrosive. However, ideal disinfectants do not exist. Most disinfectants are also, by nature, potentially harmful (even toxic) to humans or animals. Many modern household disinfectants contain Bitrex® (denatonium benzoate), an exceptionally bitter substance (aversive agent) added to discourage ingestion, as a safety measure. Use of additional substances (such as denatonium benzoate) in an industrial disinfectant may cause issues or concerns with effectiveness, long-term stability and/or corrosiveness.

The choice of disinfectant to be used depends on the particular situation. Some disinfectants have a wide spectrum (kill many different types of microorganisms), while others kill a smaller range of disease-causing organisms but are preferred for other properties (they may be non-corrosive, non-toxic, or inexpensive).

### SUMMARY OF THE INVENTION

In specific embodiments, the present invention provides for a composition that can effectively reduce the number of microbes located upon a substrate. In such embodiments, the composition can effectively kill and/or inhibit a microorganism (e.g., virus, fungus, mold, slime mold, algae, yeast, mushroom and/or bacterium), thereby disinfecting the substrate. In specific embodiments, at least 6 logs of desired microorganism (e.g., P. aeruginosa, S. aureus, E. hirae, M. terrae, M. intracellulare, M. avium and/or M. avium complex (MAC)) is inactivated, for example, in about 5 minutes, or less. In additional specific embodiments, the composition is formulated as a liquid concentrate disinfectant, and can subsequently be diluted with a carrier (e.g., water) prior to use. In additional specific embodiments, the composition is non-corrosive and/or non-toxic. In additional specific embodiments, the composition is formulated as a one-part composition, and has a long-term stability (e.g., at least about a month). In additional specific embodiments, the composition can effectively sanitize a substrate, thereby simultaneously cleaning and disinfecting the substrate. In additional specific embodiments, the composition can be highly compatible with common materials of medical devices including endoscopes and automated endoscope reprocessing systems including stainless steel, ceramics, glass, plastics, and elastomers.

The present invention provides for a composition that includes: (a) hydrogen peroxide; (b) at least one of an inorganic acid and an organic acid; (c) chelator; (d) anticorrosive agent; and (e) surfactant.

The present invention also provides for a one part, liquid concentrate disinfectant that includes: (a) about 20-30 wt. % hydrogen peroxide; (b) about 5-20 wt. % of an inorganic acid, organic acid, or combination thereof; (c) about 1-3 wt. % chelator; (d) about 0.5-5 wt. % anticorrosive agent; and (e) about 2-8 wt. % surfactant.

The present invention also provides for a one part, liquid concentrate disinfectant composition that includes: (a) about 20-30 wt. % hydrogen peroxide, which is about 35% (w/w) in water; (b) about 9-20 wt. % glacial acetic acid; (c) about 1.5 wt. % Dequest® 2010 (1-hydroxyethylidene-1,1,-diphosphonic acid, HEDP); (d) about 1 wt. % benzotriazole, or about 2 wt. % sodium dodecyl sulfate (SDS); (e) about 4 wt. % combined of Pluronic® L44 surfactant Poloxamer 124 block copolymer, Pluronic 10R5 Reverse Triblock copolymer, or combination thereof; and (f) about 0.3 wt. % phosphoric acid, which is about 85% (w/w) in water.

The present invention also provides for a kit that includes: (a) an enclosed container that includes a removable closure; (b) the composition as described herein, located inside the enclosed container, and (c) printed indicia located on the enclosed container.

The present invention also provides for a method of reducing the number of microbes located upon a substrate. The method includes contacting the substrate with an effective amount of the composition described herein, for a sufficient period of time, effective to reduce the number of microbes located upon the substrate.

The present invention also provides for a method of killing or inhibiting a microorganism. The method includes contacting the microorganism with an antimicrobially effective amount of the composition described herein, for a sufficient period of time, effective to kill or inhibit the microorganism.

The present invention also provides for a method of disinfecting a substrate. The method includes contacting the substrate with an effective amount of the composition described herein, for a sufficient period of time, effective to disinfect the substrate.

### DETAILED DESCRIPTION OF THE INVENTION

Reference will now be made in detail to certain claims of the present invention, examples of which are illustrated in the accompanying structures and formulas. While the disclosed present invention will be described in conjunction with the enumerated claims, it will be understood that the disclosed present invention is not intended to limit those claims. On the contrary, the disclosed present invention is intended to cover all alternatives, modifications, and equivalents, which can be included within the scope of the present invention, as defined by the claims.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” should be interpreted to include not only the explicitly recited amount of about 0.1 wt % to about 5 wt %, but also the individual concentrations (e.g., 1%, 2%, 3%, and 4%) and the sub-ranges (e.g., 0.5%, 1.1%, 2.2%, 3.3%, and 4.4%) within the indicated range.

The present invention relates to antimicrobial compositions, methods of using the antimicrobial compositions, and/or kits that include the antimicrobial compositions. In specific embodiments, the composition includes: (a) hydrogen peroxide; (b) at least one of an inorganic acid and an organic acid; (c) chelator; (d) anticorrosive agent; and (e) surfactant. When describing the present invention, the following terms have the following meanings, unless otherwise indicated.

The term “about” can allow for a degree of variability in a value or range, for example, within 10%, within 5%, or within 1% of a stated value or of a stated limit of a range.

The term “hydrogen peroxide” or “H₂O₂”refers to the compound chemically designated as dihydrogen dioxide, having the CAS Reg. No. 7722-84-1. In specific embodiments of the invention, the hydrogen peroxide includes water. In further specific embodiments of the invention, the hydrogen peroxide is 35% (w/w) hydrogen peroxide in water. The hydrogen peroxide can be present in the composition, in any suitable and effective amount. In specific embodiments of the invention, the hydrogen peroxide (e.g., 35% (w/w) hydrogen peroxide in water) can be present in about 20 wt. % to about 30 wt. % of the composition.

The term “inorganic acid” or “mineral acid” refers to an acid derived from one or more inorganic compounds. A mineral acid is not organic and all mineral acids release hydrogen ions when dissolved in water. Examples of inorganic acids include, e.g., sulfuric acid (H₂SO₄), hydrochloric acid (HCl), phosphoric acid (H₃PO₄), and nitric acid (HNO₃).

The term “phosphoric acid” or “H₃PO₄” refers to the compound chemically designated as trihydroxidooxidophosphorus phosphoric acid, having the CAS Reg. No. 7664-38-2. In specific embodiments, the phosphoric acid is phosphoric acid, about 85% (w/w) in water.

The term “phosphoric acid, about 85% (w/w) in water” refers to phosphoric acid that is undiluted and relatively concentrated, such that it includes less than about 15% (w/w) water.

In specific embodiments, the phosphoric acid is essentially free of transition metals. In additional specific embodiments, the phosphoric acid includes less than about 0.001 wt. % transition metals. Having the phosphoric acid include a minimal amount of transition metals decreases the likelihood that the transition metals will case degradation and/or decomposition of the composition, over the extended periods of time associates with the manufacturing, shipping, and storage of the composition. This is especially so when the composition is formulated as a concentrated, one-part composition.

The term “organic acid” refers to an organic compound with acidic properties. The most common organic acids are the carboxylic acids, whose acidity is associated with their carboxyl group —COOH, Sulfonic acids, containing the group —SO₂OH, are relatively stronger acids. The relative stability of the conjugate base of the acid determines its acidity. Other groups can also confer acidity, usually weakly: —OH, —SH, the enol group, and the phenol group. Organic compounds containing these groups are generally referred to as organic acids. An example of an organic acid is acetic acid.

The term “acetic acid” or “ethanoic acid” refers to an organic compound with the chemical formula CH₃CO₂H (also written as CH₃COOH), having the CAS Reg. No. 64-19-7. In a specific embodiment of the invention, the acetic acid is present in at least about 5 wt. % of the composition. In an additional specific embodiment of the invention, the acetic acid is present in about 7 wt. % to about 14 wt. % of the composition. In a further specific embodiment of the invention, the acetic acid is glacial acetic acid.

The term “glacial acetic acid” refers to undiluted and relatively concentrated, water-free (anhydrous) acetic acid.

The term “chelator,” “chelant” or “chelating agent” refers to a compound that forms soluble, complex molecules with certain metal ions, inactivating the metal ions (or to some extent, countering the effects of the metal ions), so that they cannot normally react with other compounds, elements or ions. In specific embodiments, the chelator effectively chelates transition metals. One suitable chelator is 1-hydroxyethane 1,1-diphosphonic acid. In specific embodiments, the chelator will effectively chelate any transition metals present in any of the components of the composition, e.g., phosphoric acid, hydrogen peroxide, etc.

The term “Dequest® 2010” refers to the compound (1-hydroxyethylidene-1,1,-diphosphonic acid, or 1-hydroxyethane 1,1-diphosphonic acid, or HEDP. It has a CAS Reg. No. of 2809-21-4. In specific embodiments, the Dequest® 2010 (1-hydroxyethylidene-1,1,-diphosphonic acid, HEDP) is present in at least about 0.5 wt. % of the composition. In additional specific embodiments, the Dequest® 2010 (1-hydroxyethylidene-1,1,-diphosphonic acid, HEDP) is present in about 0.5 wt. % to about 3.0 wt. % of the composition.

The term “anticorrosive agent” or “corrosion inhibitor” refers to a compound that, when added to a liquid or gas, decreases the corrosion rate of a material, typically a metal or an alloy. Suitable anticorrosive agents include, e.g., benzotriazole and sodium dodecyl sulfate (SDS).

The term “benzotriazole” or “BTA” refers to the compound 1H-benzotriazole or 1,2,3-benzotriazole, having the CAS Reg. No. 95-14-7, and the chemical structure shown below:

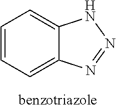

In specific embodiments, the benzotriazole is present in at least about 0.25 wt. % of the composition. In additional specific embodiments, the benzotriazole is present in about 0.5 wt. % to about 2.0 wt. % of the composition.

The term “surfactant” refers to a compound capable of lowering the surface tension of a liquid, the interfacial tension between two liquids, or that between a liquid and a solid. Surfactants may act as detergents, wetting agents, emulsifiers, foaming agents, and/or dispersants. The surfactant can be non-ionic, anionic or cationic. Additionally, the surfactant can include one or more non-ionic surfactants, one or more anionic surfactants, and/or one or more cationic surfactants.

The term “non-ionic surfactant” or “nonionic surfactant” refers to a surfactant, in which the total number of electrons is equal to the total number of protons, giving it a net neutral or zero electrical charge. One suitable class of non-ionic surfactants includes the Pluronics® poloxamers.

Poloxamers are nonionic triblock copolymers composed of a central hydrophobic chain of polyoxypropylene (poly(propylene oxide)) flanked by two hydrophilic chains of polyoxyethylene (poly(ethylene oxide)). Poloxamers are also known by the trade name Pluronics®.

Because the lengths of the polymer blocks can be customized, many different poloxamers exist, that have slightly different properties. For the generic term “poloxamer,” these copolymers are commonly named with the letter “P” (for poloxamer) followed by three digits, the first two digits×100 give the approximate molecular mass of the polyoxypropylene core, and the last digit×10 gives the percentage polyoxyethylene content (e.g., P407=Poloxamer with a polyoxypropylene molecular mass of 4,000 g/mol and a 70% polyoxyethylene content). For the Pluronic® tradename, coding of these copolymers starts with a letter to define its physical form at room temperature (L=liquid, P=paste, F=flake (solid)) followed by two or three digits. The first digit (two digits in a three-digit number) in the numerical designation, multiplied by 300, indicates the approximate molecular weight of the hydrophobe; and the last digit×10 gives the percentage polyoxyethylene content (e.g., L61=Pluronic with a polyoxypropylene molecular mass of 1,800 g/mol and a 10% polyoxyethylene content). In the example given, poloxamer 181 (P181)=Pluronic L61.

The term “Pluronic® L44 surfactant Poloxamer 124 block copolymer” refers to specific nonionic triblock copolymers composed of a central hydrophobic chain of polyoxypropylene (poly(propylene oxide)) flanked by two hydrophilic chains of polyoxyethylene (poly(ethylene oxide)). In specific embodiments, the Pluronic® L44 surfactant Poloxamer 124 block copolymer is present in at least about 2.0 wt. % of the composition. In additional specific embodiments, the Pluronic® L44 surfactant Poloxamer 124 block copolymer is present in about 2.0 wt. % to about 8 wt. % of the composition.

The term “anionic surfactant” refers to a surfactant in which the total number of electrons is greater than the total number of protons, giving it a net negative electrical charge. One suitable anionic surfactant is sodium lauryl sulfate.

The term “sodium dodecyl sulfate,” “SDS,” “NaDS,” “sodium lauryl sulfate,” or “SLS” refers to an organic compound with the formula CH₃(CH₂)₁₁OSO₃Na), having the CAS Reg. No. 151-21-3, and the chemical structure shown below:

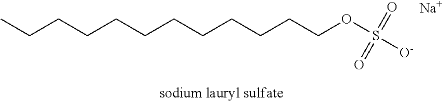 [SMILES: CCCCCCCCCCCCOS(=O)(=O)[O-] ; [Na+]]

In specific embodiments, the sodium dodecyl sulfate is present in at least about 1.0 wt. % of the composition. In additional specific embodiments, the sodium dodecyl sulfate is present in about 1.0 wt. % to about 2.0 wt. % of the composition.

The term “cationic surfactant” refers to a surfactant, in which the total number of electrons is less than the total number of protons, giving it a net positive electrical charge.

In specific embodiments, the composition of the present invention can have a pH of less than about 3. In further specific embodiments, the composition of the present invention can have a pH of less than about 2.5. In specific embodiments, the composition of the present invention can have a pH of less than about 2. In specific embodiments, the composition of the present invention can have a pH of less than about 1.75.

In specific embodiments, the composition of the present invention can be formulated as, can exist as, and can be commercially available as a liquid concentrate disinfectant. The term “liquid concentrate” refers to a composition that is relatively undiluted and concentrated, having a low content of carrier, e.g., water. Having the composition be commercially available as a liquid concentrate will typically save costs associated with the manufacturing, shipping, and/or storage of the product.

When the composition of the present invention is formulated as a liquid concentrate, the concentrate can subsequently be diluted with an appropriate amount of carrier (e.g., water) prior to use. Additionally, although considered to be a concentrate, when the composition of the present invention is formulated as a liquid concentrate, a discrete and finite amount of carrier (e.g., water) can be employed.

The term “disinfectant” refers to a substance that when applied to non-living objects, destroys microorganisms that are living on the objects. Disinfection does not necessarily kill all microorganisms, especially nonresistant bacterial spores; it is less effective than sterilization, which is an extreme physical and/or chemical process that kills all types of life.

Disinfectants are different from other antimicrobial agents such as antibiotics, which destroy microorganisms within the body, and antiseptics, which destroy microorganisms on living tissue. Disinfectants are also different from biocides. The latter are intended to destroy all forms of life, not just microorganisms. Sanitizers are substances that simultaneously clean and disinfect.

In specific embodiments, the composition of the present invention can be non-corrosive. The term “non-corrosive” or “noncorrosive” refers to a substance that will not destroy or irreversibly damage another surface or substance with which it comes into contact. The main hazards to people include damage to the eyes, the skin, and the tissue under the skin; inhalation or ingestion of a corrosive substance can damage the respiratory and gastrointestinal tracts. Exposure results in chemical burn. Having the composition be relatively non-corrosive will allow the user to employ the composition over a wider range of uses, exposing the composition to a wider range of substrates. For example, having the composition be relatively non-corrosive will allow the user to employ the composition as a disinfectant with certain medical devices that are highly sensitive to corrosive substances.

In specific embodiments, the composition of the present invention can be non-toxic. The term “non-toxic” refers to a substance that has a relatively low degree to which it can damage a living or non-living organism. Toxicity can refer to the effect on a whole organism, such as an animal, bacterium, or plant, as well as the effect on a substructure of the organism, such as a cell (cytotoxicity) or an organ (organotoxicity), such as the liver (hepatotoxicity). A central concept of toxicology is that effects are dose-dependent; even water can lead to water intoxication when taken in large enough doses, whereas for even a very toxic substance such as snake venom there is a dose below which there is no detectable toxic effect. Having the composition be relatively non-toxic will allow a wider range of users be able to safely handle the composition, without serious safety concerns or risks.

In specific embodiments, the composition of the present invention can be stable over extended periods of time (i.e., has a long-term stability). The term “long-term stability” refers to a substance undergoing little or no physical and/or chemical decomposition or degradation, over extended periods of time.

In further specific embodiments, the composition of the present invention can be stable over extended periods of time, such that at about 1 atm and about 19° C., less than about 5 wt. % of each component independently degrades over about one year. In additional specific embodiments, the composition of the present invention can be stable over extended periods of time, such that at about 1 atm and about 19° C., at least about 95 wt. % of each component is independently present after about one year.

Having the composition be relatively stable over extended periods of time will allow the composition to retain its effectiveness over that time, ensuring that it will remain useful and active for its intended purpose. In contrast, in those compositions that do not retain their effectiveness over that time, product loss can result, which can be financially costly. Additionally, risks associated with the use of a product that has lost some or all of its effectiveness for the intended purpose can be hazardous, in that the product may not effectively achieve the desired goal. For example, when used to disinfect a medical device, use of a composition that has lost some or all of its effectiveness as a disinfectant may not effectively disinfect the medical device. Medical injuries can be sustained by the patient, including serious infections.

In specific embodiments, the composition of the present invention can be formulated as, can exist as, and is commercially available as, a one-part composition. The term “one-part composition” refers to all chemical components of a composition being present together, such that they are each in intimate and physical contact with one another, and are each present in a single container. Having the composition be commercially available as a one-part composition will be more cost effective (e.g., lower manufacturing costs associated with fewer containers), and will avoid the necessity of the user mixing or combining multiple components together, prior to using.

In specific embodiments, the composition of the present invention can be essentially free of buffer. In further specific embodiments, the composition of the present invention can include less than about 0.1 wt. % buffer. The term “buffer,” “buffering agent,” or “buffering substance” refers to a weak acid or base used to maintain the acidity (pH) of a solution at a chosen value. The function of a buffering agent is to prevent a rapid change in pH when acids or bases are added to the solution. Buffering agents have variable properties—some are more soluble than others; some are acidic while others are basic. In specific embodiments, the composition of the present invention can be essentially free of transition metals. In further specific embodiments, the composition of the present invention can include less than about 0.001 wt. % transition metals. In further specific embodiments, the composition of the present invention can include less than about 0.0001 wt. % transition metals. In further specific embodiments, the composition of the present invention can include less than about 0.00001 wt. % transition metals. Having the composition include a minimal amount of transition metals decreases the likelihood that the transition metals will case degradation and/or decomposition of the composition, over the extended periods of time associates with the manufacturing, shipping, and storage of the composition. This is especially so when the composition is formulated as a concentrated, one-part composition.

The term “transition metal,” “transition metals” or “transition element” refers to an element whose atom has an incomplete d sub-shell, or which can give rise to cations with an incomplete d sub-shell. Transition metals include scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg), rutherfordium (Rf), dubnium (Db), seaborgium (Sg), bohrium (Bh), hassium (Hs) and copernicium (Cn).

In specific embodiments of the invention, the transition metal can be naturally occurring. Naturally occurring transition metals include scandium (Sc), titanium (Ti), vanadium (V), chromium (Cr), manganese (Mn), iron (Fe), cobalt (Co), nickel (Ni), copper (Cu), zinc (Zn), yttrium (Y), zirconium (Zr), niobium (Nb), molybdenum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), and mercury (Hg).

In specific embodiments, the composition of the present invention can be essentially free of heavy metals. In further specific embodiments, the composition of the present invention can include less than about 0.001 wt. % heavy metals. In further specific embodiments, the composition of the present invention can include less than about 0.0001 wt. % heavy metals. In further specific embodiments, the composition of the present invention can include less than about 0.00001 wt. % heavy metals. Having the composition include a minimal amount of heavy metals decreases the likelihood that the transition metals will case degradation and/or decomposition of the composition, over the extended periods of time associates with the manufacturing, shipping, and storage of the composition. This is especially so when the composition is formulated as a concentrated, one-part composition.

The term “heavy metal,” “heavy metals” or “toxic metal” refers to metals that are relatively toxic, and mainly include the transition metals, some metalloids, lanthanides, and actinides. Examples of toxic metals include, e.g., iron (Fe), cobalt (Co), copper (Cu), manganese (Mn), molybdenum (Mo), zinc (Zn), mercury (Hg), plutonium (Pu), lead (Pb), vanadium (V), tungsten (W), cadmium (Cd), aluminum (Al), beryllium (Be), and arsenic (As).

The present invention also provides for a kit that includes: (a) an enclosed container that includes a removable closure; (b) the composition of the present invention as described herein, which is located inside the enclosed container; and (c) printed indicia located on the enclosed container.

In specific embodiments, the enclosed container can be opaque. In additional specific embodiments, the enclosed container can be manufactured from high density polyethylene (HDPE), thereby providing the requisite opacity. Having the enclosed container be manufactured from high density polyethylene (HDPE) will decrease the likelihood that the composition will degrade and/or decompose over extended periods of time, due to excessive exposure to direct sunlight.

The term “high-density polyethylene” or “HDPE” refers to a polyethylene thermoplastic made from petroleum. The mass density of high-density polyethylene can range from 0.93 to 0.97 g/cm³. Although the density of HDPE is only marginally higher than that of low-density polyethylene, HDPE has little branching, giving it stronger intermolecular forces and tensile strength than LDPE. The difference in strength exceeds the difference in density, giving HDPE a higher specific strength. It is also harder and more opaque and can withstand somewhat higher temperatures (120° C./248° F. for short periods, 110° C./230° F. continuously). HDPE is resistant to many different solvents.

The term “opaque” refers to an object that is neither transparent (allowing all light to pass through) nor translucent (allowing some light to pass through). When light strikes an interface between two substances, in general some may be reflected, some absorbed, some scattered, and the rest transmitted (also see refraction). Reflection can be diffuse, for example light reflecting off a white wall, or specular, for example light reflecting off a mirror. An opaque substance transmits no light, and therefore reflects, scatters, or absorbs all of it. Both mirrors and carbon black are opaque. Opacity depends on the frequency of the light being considered. For instance, some kinds of glass, while transparent in the visual range, are largely opaque to ultraviolet light. More extreme frequency-dependence is visible in the absorption lines of cold gases.

To further decrease the likelihood that the composition will degrade and/or decompose over extended periods of time, the composition should avoid, when feasible: excessive exposure to direct sunlight, excessive heat and/or elevated temperatures. As such, in specific embodiments, the enclosed container of the kit can include printed indicia, with instructions to avoid excessive heat, elevated temperatures, direct sunlight, or a combination thereof.

Over extended periods of time, hydrogen peroxide present in the composition will be susceptible to degrade or decompose (and a portion of the hydrogen peroxide may degrade or decompose), thereby evolving oxygen (O₂), as shown below.

2H₂O₂- - - >2H₂O+O₂

In specific embodiments, the enclosed container includes a head space, pressure valve, or combination thereof. In specific embodiments, the enclosed container includes a pressure valve, configured to release excessive gas from within the enclosed container. The presence of a head space and pressure valve in the container will allow for the escape of gas (e.g., oxygen) from the enclosed container, without the likelihood that the container will explode from the elevated pressure that would otherwise develop.

The term “head space” refers to a portion of the inside of a container that is not occupied by the liquid contents of the container. In particular, when a container includes a liquid composition, a head space can be present in the container such that a portion of the inside of the container does not include liquid composition, but instead includes a gas or vacuum. In specific embodiments, the head space can include oxygen (O₂). In further specific embodiments, the head space can be present in up to about 5% (v/v) of the inside of the enclosed container.

The term “pressure valve” refers to a mechanical device that will permit for the passage of gas and not fluid, preferably in one direction only, for example, exiting a container housing the pressure valve, and not entering the container.

The composition of the present invention can be used to effectively reduce the number of microbes located upon a substrate. In specific embodiments, the composition can effectively kill and/or inhibit a microorganism (e.g., virus, fungus, mold, slime mold, algae, yeast, mushroom and/or bacterium), thereby disinfecting the substrate.

In specific embodiments of the present invention, up to about 2 logs of desired microorganism (e.g., P. aeruginosa, S. aureus, E. hirae, M. terrae, M. intracellulare, M. avium and/or M. avium complex) is inactivated, for example, in about 5 minutes, or less. In further specific embodiments, up to about 3 logs of desired microorganism is inactivated, for example, in about 5 minutes, or less. In further specific embodiments, up to about 4 logs of desired microorganism is inactivated, for example, in about 5 minutes, or less. In further specific embodiments, up to about 5 logs of desired microorganism is inactivated, for example, in about 5 minutes, or less. In further specific embodiments, up to about 6 logs of desired microorganism is inactivated, for example, in about 5 minutes, or less. In further specific embodiments, up to about 7 logs of desired microorganism is inactivated, for example, in about 5 minutes, or less.

In additional specific embodiments, the composition can effectively sanitize a substrate, thereby simultaneously cleaning and disinfecting the substrate. In additional specific embodiments, the composition can effectively kill or inhibit all forms of life, not just microorganisms, thereby acting as a biocide.

In specific embodiments, the composition can effectively disinfectant a substrate. In further specific embodiments, the composition can effectively disinfectant the surface of a substrate. In additional specific embodiments, the composition can effectively sterilize a substrate. In further specific embodiments, the composition can effectively sterilize the surface of a substrate.

In specific embodiments, the composition can be employed as a disinfectant solution for high-level disinfection. In additional specific embodiments, the composition can be employed as a disinfectant solution, for high-level disinfection, for the reprocessing of endoscopes and related accessories. In additional specific embodiments, the composition can be employed as a disinfectant solution, for high-level disinfection, for the reprocessing of endoscopes and related accessories in a Wassenburg automatic endoscope washer disinfector. In additional specific embodiments, the composition can be employed as a disinfectant solution, for high-level disinfection, for the reprocessing of endoscopes and related accessories in a Wassenburg automatic endoscope washer disinfector, at or above a concentration of 450 ppm peracetic acid, with a contact time of at least 5 minutes at a minimum temperature of 40° C.

In specific embodiments, the composition can be employed as a disinfectant solution for high-level disinfection of a medical device, wherein the composition has at least one of sporicidal, tuberculocidal, virucidal, fungicidal, and bactericidal activity. In further specific embodiments, the composition will have a minimum contact time, e.g., of about 5 minutes at a minimum temperature, e.g., of about 40° C.

The composition of the present invention can be formulated for application, depending upon the user's preference as well as the ultimate application of the composition. For example, the composition can be formulated for use in a sprayable composition, atomized liquid sprayer, or liquid applicator. Such formulations can include at least one of a spray bottle, motorized sprayer, wipe, cloth, sponge, non-woven fabric, and woven fabric. Such formulations may be particularly suitable for applying the composition to a surface of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and/or clean room.

Such liquid formulations may be particularly suitable for applying the composition to metal, plastic, natural rubber, synthetic rubber, glass, stone, grout, fiberglass, wood, concrete, construction products, and/or building products.

In specific embodiments, the composition of the invention can be configured for use in contacting at least one of medical equipment, medical device (e.g., reusable medical device or instrument, such as a colonoscope), surface in the medical industry, dental equipment, dental device, and surface in the dental industry. In a further specific embodiment, the composition of the invention can be configured for use in contacting a medical device (e.g., reusable medical device or instrument).

The term “microbe,” “microbes” “microorganism,” or “micro-organism” refers to a microscopic organism that comprises either a single cell (unicellular), cell clusters, or no cell at all (acellular). Microorganisms are very diverse; they include bacteria, fungi, archaea, and protists; microscopic plants (green algae); and animals such as plankton and the planarian. Some microbiologists also include viruses, but others consider these as non-living. Most microorganisms are unicellular (single-celled), but this is not universal, since some multicellular organisms are microscopic, while some unicellular protists and bacteria, like Thiomargarita namibiensis, are macroscopic and visible to the naked eye.

The term “virus” refers to a small infectious agent that can replicate only inside the living cells of organisms. Virus particles (known as virions) consist of two or three parts: the genetic material made from either DNA or RNA, long molecules that carry genetic information; a protein coat that protects these genes; and in some cases an envelope of lipids that surrounds the protein coat when they are outside a cell. The shapes of viruses range from simple helical and icosahedral forms to more complex structures. The average virus is about one one-hundredth the size of the average bacterium. An enormous variety of genomic structures can be seen among viral species; as a group they contain more structural genomic diversity than plants, animals, archaea, or bacteria. There are millions of different types of viruses, although only about 5,000 of them have been described in detail. A virus has either DNA or RNA genes and is called a DNA virus or a RNA virus respectively. The vast majority of viruses have RNA genomes. Plant viruses tend to have single-stranded RNA genomes and bacteriophages tend to have double-stranded DNA genomes.

The term “fungi” or “fungus” refers to a large and diverse group of eucaryotic microorganisms whose cells contain a nucleus, vacuoles, and mitochondria. Fungi include algae, molds, yeasts, mushrooms, and slime molds. See, Biology of Microorganisms, T. Brock and M. Madigan, 6th Ed., 1991, Prentice Hill (Englewood Cliffs, N.J.). Exemplary fungi include Ascomycetes (e.g., Neurospora, Saccharomyces, Morchella), Basidiomycetes (e.g., Amanita, Agaricus), Zygomycetes (e.g., Mucor, Rhizopus), Oomycetes (e.g., Allomyces), and Deuteromycetes (e.g., Penicillium, Aspergillus).

The term “mold” refers to a filamentous fungus, generally a circular colony that may be cottony, wooly, etc. or glabrous, but with filaments not organized into large fruiting bodies, such as mushrooms. See, e.g., Stedman's Medical Dictionary, 25th Ed., Williams & Wilkins, 1990 (Baltimore, Md.). One exemplary mold is the Basidiomycetes called wood-rotting fungi. Two types of wood-rotting fungi are the white rot and the brown rot. An ecological activity of many fungi, especially members of the Basidiomycetes is the decomposition of wood, paper, cloth, and other products derived from natural sources. Basidiomycetes that attack these products are able to utilize cellulose or lignin as carbon and energy sources. Lignin is a complex polymer in which the building blocks are phenolic compounds. It is an important constituent of woody plants. The decomposition of lignin in nature occurs almost exclusively through the agency of these wood-rotting fungi. Brown rot attacks and decomposes the cellulose and the lignin is left unchanged. White rot attacks and decomposes both cellulose and lignin. See, Biology of Microorganisms, T. Brock and M. Madigan, 6th Ed., 1991, Prentice Hill (Englewood Cliffs, N.J.).

The term “slime molds” refers to nonphototrophic eucaryotic microorganisms that have some similarity to both fungi and protozoa. The slime molds can be divided into two groups, the cellular slime molds, whose vegetative forms are composed of single amoebalike cells, and the acellular slime molds, whose vegetive forms are naked masses of protoplasms of indefinite size and shape called plasmodia. Slime molds live primarily on decaying plant matter, such as wood, paper, and cloth. See, Biology of Microorganisms, T. Brock and M. Madigan, 6th Ed., 1991, Prentice Hill (Englewood Cliffs, N.J.).

The term “algae” refers to a large and diverse assemblage of eucaryotic organisms that contain chlorophyll and carry out oxygenic photosynthesis. See, Biology of Microorganisms, T. Brock and M. Madigan, 6th Ed., 1991, Prentice Hill Englewood Cliffs, N.J.). Exemplary algae include Green Algae (e.g., Chlamydomonas), Euglenids (e.g., Euglena), Golden Brown Algae (e.g., Navicula), Brown Algae (e.g., Laminaria), Dinoflagellates (e.g., Gonyaulax), and Red Algae (e.g., polisiphonia).

The term “yeast” refers to unicellular fungi, most of which are classified with the Ascomytes. See, Biology of Microorganisms, T. Brock and M. Madigan, 6th Ed., 1991, Prentice Hill (Englewood Cliffs, N.J.).

The term “mushrooms” refer to filamentous fungi that are typically from large structures called fruiting bodies, the edible part of the mushroom. See, Biology of Microorganisms, T. Brock and M. Madigan, 6th Ed., 1991, Prentice Hill (Englewood Cliffs, N.J.).

The term “bacterium” or “bacteria” refers to a large domain of prokaryotic microorganisms. Typically a few micrometers in length, bacteria have a wide range of shapes, ranging from spheres to rods and spirals. Bacteria are present in most habitats on Earth, growing in soil, acidic hot springs, radioactive waste, water, and deep in the Earth's crust, as well as in organic matter and the live bodies of plants and animals, providing outstanding examples of mutualism in the digestive tracts of humans, termites and cockroaches. There are typically about 40 million bacterial cells in a gram of soil and a million bacterial cells in a milliliter of fresh water; in all, there are approximately five nonillion (5×10³⁰) bacteria on Earth, forming a biomass that exceeds that of all plants and animals. Most bacteria have not been characterized, and only about half of the phyla of bacteria have species that can be grown in the laboratory.

The term “P. aeruginosa” or “Pseudomonas aeruginosa” refers to a common bacterium that can cause disease in animals, including humans. It is found in soil, water, skin flora, and most man-made environments throughout the world. It thrives not only in normal atmospheres, but also in hypoxic atmospheres, and has, thus, colonized many natural and artificial environments. It uses a wide range of organic material for food; in animals, the versatility enables the organism to infect damaged tissues or those with reduced immunity. The symptoms of such infections are generalized inflammation and sepsis. If such colonizations occur in critical body organs, such as the lungs, the urinary tract, and kidneys, the results can be fatal. Because it thrives on most surfaces, this bacterium is also found on and in medical equipment, including catheters, causing cross-infections in hospitals and clinics. It is implicated in hot-tub rash.

The term “S. aureus” or “Staphylococcus aureus” refers to a facultative anaerobic Gram-positive bacterium. It is frequently found as part of the normal skin flora on the skin and nasal passages. It is estimated that 20% of the human population are long-term carriers of S. aureus. S. aureus is the most common species of staphylococci to cause Staph infections. The reasons S. aureus is a successful pathogen are a combination host and bacterial immuno-evasive strategies. One of these strategies is the production of carotenoid pigment staphyloxanthin which is responsible for the characteristic golden colour of S. aureus colonies. This pigment acts as a virulence factor, primarily being a bacterial antioxidant which helps the microbe evade the hosts immune system in the form of reactive oxygen species which the host uses to kill pathogens.

S. aureus can cause a range of illnesses from minor skin infections, such as pimples, impetigo, boils (furuncles), cellulitis folliculitis, carbuncles, scalded skin syndrome, and abscesses, to life-threatening diseases such as pneumonia, meningitis, osteomyelitis, endocarditis, toxic shock syndrome (TSS), bacteremia, and sepsis. Its incidence is from skin, soft tissue, respiratory, bone, joint, endovascular to wound infections. It is still one of the five most common causes of nosocomial infections, often causing postsurgical wound infections. Each year, some 500,000 patients in American hospitals contract a staphylococcal infection.

Methicillin-resistant S. aureus, abbreviated MRSA and often pronounced “mersa” (in North America), is one of a number of greatly-feared strains of S. aureus which have become resistant to most antibiotics. MRSA strains are most often found associated with institutions such as hospitals, but are becoming increasingly prevalent in community-acquired infections.

The term “E. hirae” or “Enterococcus hirae” refers to a species of Enterococcus. The term “M. terrae” or “Mycobacterium terrae” refers to a slow-growing species of Mycobacterium. It is an ungrouped member of the third Runyon (nonchromatogenic mycobacteria). It is known to cause serious skin infections, which are relatively resistant to antibiotic therapy.

The term “Mycobacterium avium complex,” “M. avium complex” or “MAC” refers to a group of genetically related bacteria belonging to the genus Mycobacterium. It includes Mycobacterium avium and Mycobacterium intracellulare.

The term “M. avium” or “mycobacterium avium” refers to a species of Mycobacterium.

The term “M. intracellulare” or “mycobacterium intracellulare” refers to a species of Mycobacterium.

### ENUMERATED EMBODIMENTS

Specific enumerated embodiments [1] to [63] provided below are for illustration purposes only, and do not otherwise limit the scope of the invention, as defined by the claims. These enumerated embodiments encompass all combinations, sub-combinations, and multiply referenced (e.g., multiply dependent) combinations described therein.

[1.] In one embodiment, the present invention provides for a composition that includes:
(a) hydrogen peroxide;
(b) at least one of an inorganic acid and an organic acid;
(c) chelator;
(d) anticorrosive agent; and
(e) surfactant.

[2.] In another embodiment, the present invention provides for the composition of embodiment [1], which is a liquid concentrate disinfectant.

[3.] In another embodiment, the present invention provides for the composition of any one of the above embodiments, which is non-corrosive.

[4.] In another embodiment, the present invention provides for the composition of any one of the above embodiments, which is non-toxic.

[5.] In another embodiment, the present invention provides for the composition of any one of the above embodiments, having a long-term stability such that at about 1 atm and about 19° C., less than about 5 wt. % of each component independently degrades over about one year.

[6.] In another embodiment, the present invention provides for the composition of any one of the above embodiments, having a long-term stability such that at about 1 atm and about 19° C., at least about 95 wt. % of each component is independently present after about one year.

[7.] In another embodiment, the present invention provides for the composition of any one of the above embodiments, which is a one-part composition.

[8.] In another embodiment, the present invention provides for the composition of any one of the above embodiments, which is essentially free of buffer.

[9.] In another embodiment, the present invention provides for the composition of any one of the above embodiments, that includes less than about 0.1 wt. % buffer.

[10.] In another embodiment, the present invention provides for the composition of any one of the above embodiments, wherein the hydrogen peroxide is 35% (w/w) in water, present in at least about 20 wt. % of the composition.

[11.] In another embodiment, the present invention provides for the composition of any one of the above embodiments, wherein the hydrogen peroxide is about 35% (w/w) in water, present in about 20 wt. % to about 30 wt. % of the composition.

[12.] In another embodiment, the present invention provides for the composition of any one of the above embodiments, wherein the organic acid includes acetic acid.

[13.] In another embodiment, the present invention provides for the composition of any one of the above embodiments, wherein the organic acid includes glacial acetic acid.

[14.] In another embodiment, the present invention provides for the composition of any one of the above embodiments, wherein the organic acid includes acetic acid, present in at least about 5 wt. % of the composition.

[15.] In another embodiment, the present invention provides for the composition of any one of the above embodiments, wherein the organic acid includes acetic acid, present in about 9 wt. % to about 20 wt. % of the composition.

[16.] In another embodiment, the present invention provides for the composition of any one of the above embodiments, wherein inorganic acid includes phosphoric acid.

[17.] In another embodiment, the present invention provides for the composition of any one of the above embodiments, wherein inorganic acid includes phosphoric acid, about 85% (w/w) in water.

[18.] In another embodiment, the present invention provides for the composition of any one of the above embodiments, wherein the inorganic acid includes phosphoric acid, that includes less than about 0.001 wt. % transition metals.

[19.] In another embodiment, the present invention provides for the composition of any one of the above embodiments, wherein the inorganic acid includes phosphoric acid and the organic acid includes acetic acid.

[20.] In another embodiment, the present invention provides for the composition of any one of the above embodiments, wherein the chelator effectively chelates transition metals.

[21.] In another embodiment, the present invention provides for the composition of any one of the above embodiments, wherein the chelator includes Dequest® 2010 (1-hydroxyethylidene-1,1,-diphosphonic acid, HEDP).

[22.] In another embodiment, the present invention provides for the composition of any one of the above embodiments, wherein the chelator includes Dequest® 2010 (1-hydroxyethylidene-1,1,-diphosphonic acid, HEDP), present in at least about 0.5 wt. % of the composition.

[23.] In another embodiment, the present invention provides for the composition of any one of the above embodiments, wherein the chelator includes Dequest® 2010 (1-hydroxyethylidene-1,1,-diphosphonic acid, HEDP), present in about 0.5 wt. % to about 3.0 wt. % of the composition.

[24.] In another embodiment, the present invention provides for the composition of any one of the above embodiments, wherein the anticorrosive agent includes an anionic surfactant.

[25.] In another embodiment, the present invention provides for the composition of any one of the above embodiments, wherein the anticorrosive agent includes at least one of benzotriazole and sodium dodecyl sulfate (SDS).

[26.] In another embodiment, the present invention provides for the composition of any one of the above embodiments, wherein the anticorrosive agent includes benzotriazole, present in at least about 0.25 wt. % of the composition.

[27.] In another embodiment, the present invention provides for the composition of any one of the above embodiments, wherein the anticorrosive agent includes benzotriazole, present in about 0.5 wt. % to about 2.0 wt. % of the composition.

[28.] In another embodiment, the present invention provides for the composition of any one of the above embodiments, wherein the anticorrosive agent includes sodium dodecyl sulfate (SDS), present in at least about 1.0 wt. % of the composition.

[29.] In another embodiment, the present invention provides for the composition of any one of the above embodiments, wherein the anticorrosive agent includes sodium dodecyl sulfate (SDS), present in about 1.0 wt. % to about 2.0 wt. % of the composition.

[30.] In another embodiment, the present invention provides for the composition of any one of the above embodiments, wherein the surfactant includes a non-ionic surfactant.

[31.] In another embodiment, the present invention provides for the composition of any one of the above embodiments, wherein the surfactant includes at least one of an anionic and cationic surfactant.

[32.] In another embodiment, the present invention provides for the composition of any one of the above embodiments, wherein the surfactant includes at least one of Pluronic® L44 surfactant Poloxamer 124 block copolymer and Pluronic 10R5 Reverse Triblock copolymer.

[33.] In another embodiment, the present invention provides for the composition of any one of the above embodiments, wherein the surfactant includes at least one of Pluronic® L44 surfactant Poloxamer 124 block copolymer and Pluronic 10R5 Reverse Triblock copolymer, present in at least about 2.0 wt. % of the composition, combined.

[34.] In another embodiment, the present invention provides for the composition of any one of the above embodiments, wherein the surfactant includes at least one of Pluronic® L44 surfactant Poloxamer 124 block copolymer and Pluronic 10R5 Reverse Triblock copolymer, present in about 2.0 wt. % to about 8 wt. % of the composition, combined.

[35.] In another embodiment, the present invention provides for the composition of any one of the above embodiments, wherein the balance (q.s.) of the composition is water.

[36.] In another embodiment, the present invention provides for the composition of any one of the above embodiments, which includes less than about 0.001 wt. % heavy metals.

[37.] In another embodiment, the present invention provides for the composition of any one of the above embodiments, which is a liquid concentrate disinfectant.

[38.] In another embodiment, the present invention provides for the composition of any one of the above embodiments, formulated for use in a sprayable composition.

[39.] In another embodiment, the present invention provides for the composition of any one of the above embodiments, formulated for use in contacting a surface of at least one of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and clean room.

[40.] In another embodiment, the present invention provides for the composition of any one of the above embodiments, formulated for use in contacting at least one of metal, plastic, natural rubber, synthetic rubber, glass, stone, grout, fiberglass, wood, concrete, construction product, and building product.

[41.] In another embodiment, the present invention provides for the composition of any one of the above embodiments, formulated for use in contacting at least one of medical equipment, medical device, surface in the medical industry, dental equipment, dental device, and surface in the dental industry.

[42.] In another embodiment, the present invention provides for a one part, liquid concentrate disinfectant that includes:
(a) about 20-30 wt. % hydrogen peroxide;
(b) about 5-20 wt. % of an inorganic acid, organic acid, or combination thereof;
(c) about 1-3 wt. % chelator;
(d) about 0.5-5 wt. % anticorrosive agent; and
(e) about 2-8 wt. % surfactant.

[43.] In another embodiment, the present invention provides for a one part, liquid concentrate disinfectant that includes:
(a) about 23-26 wt. % hydrogen peroxide, which is about 35% (w/w) in water;
(b) about 10 wt. % glacial acetic acid;
(c) about 1.5 wt. % Dequest® 2010 (1-hydroxyethylidene-1,1,-diphosphonic acid, HEDP);
(d) about 1.0 wt. % benzotriazole, or about 2 wt. % sodium dodecyl sulfate (SDS);
(e) about 4 wt. % Pluronic® L44 surfactant Poloxamer 124 block copolymer; and
(f) about 0.3 wt. % phosphoric acid, which is about 85% (w/w) in water.

[44.] In another embodiment, the present invention provides for a kit that includes:
(a) an enclosed container that includes a removable closure,
(b) the composition of any one of the above embodiments, located inside the enclosed container, and
(c) printed indicia located on the enclosed container.

[45.] In another embodiment, the present invention provides for the kit of embodiment [44], wherein the enclosed container is manufactured from high density polyethylene (HDPE).

[46.] In another embodiment, the present invention provides for the kit of any one of the above embodiments, wherein the enclosed container is opaque.

[47.] In another embodiment, the present invention provides for the kit of any one of the above embodiments, wherein the printed indicia includes instructions to avoid excessive heat, to avoid elevated temperatures, to avoid direct sunlight, or a combination thereof.

[48.] In another embodiment, the present invention provides for the kit of any one of the above embodiments, wherein the enclosed container further includes a head space.

[49.] In another embodiment, the present invention provides for the kit of any one of the above embodiments, wherein the enclosed container further includes a head space, wherein the head space includes oxygen (O₂).

[50.] In another embodiment, the present invention provides for the kit of any one of the above embodiments, wherein the enclosed container further includes a head space, present in up to about 5% (v/v) of the enclosed container.

[51.] In another embodiment, the present invention provides for the kit of any one of the above embodiments, wherein the removable closure of the enclosed container includes a pressure valve, configured to release excessive gas from within the enclosed container.

[52.] In another embodiment, the present invention provides for the kit of any one of the above embodiments, further including a liquid applicator that includes at least one of a spray bottle, wipe, cloth, sponge, non-woven fabric, and woven fabric.

[53.] In another embodiment, the present invention provides a method of reducing the number of microbes located upon a substrate, the method includes contacting the substrate with an effective amount of the composition of any one of the above embodiments, for a sufficient period of time, effective to reduce the number of microbes located upon the substrate.

[54.] In another embodiment, the present invention provides a method of killing or inhibiting a microorganism, the method includes contacting the microorganism with an antimicrobially effective amount of the composition of any one of any one of the above embodiments, for a sufficient period of time, effective to kill or inhibit the microorganism.

[55.] In another embodiment, the present invention provides for a method of disinfecting a substrate, the method includes contacting the substrate with an effective amount of the composition of any one of any one of the above embodiments, for a sufficient period of time, effective to disinfect the substrate.

[56.] In another embodiment, the present invention provides for the method of any one of the above embodiments, wherein the microbe or microorganism includes at least one of a virus, fungus, mold, slime mold, algae, yeast, mushroom and bacterium.

[57.] In another embodiment, the present invention provides for the method of any one of the above embodiments, wherein at least 6 logs of desired microorganism is inactivated in about 5 minutes, or less.

[58.] In another embodiment, the present invention provides for the method of any one of the above embodiments, wherein at least 6 logs of at least one of P. aeruginosa, S. aureus, E. hirae, M. terrae, M. intracellulare, and M. avium are inactivated in about 5 minutes, or less.

[59.] In another embodiment, the present invention provides for the method of any one of the above embodiments, wherein at least about 6 logs of Mycobacterium terrae is inactivated in about 5 minutes, or less.

[60.] In another embodiment, the present invention provides for the method of any one of the above embodiments, wherein about 1 wt. % of the composition is employed, in combination with about 99 wt. % carrier.

[61.] In another embodiment, the present invention provides for the method of any one of the above embodiments, wherein about 1 wt. % of the composition is employed, in combination with about 99 wt. % water.

[62.] In another embodiment, the present invention provides for the method of any one of the above embodiments, wherein the composition has a pH of less than about 3.

[63.] In another embodiment, the present invention provides for the method of any one of the above embodiments, wherein the composition has a pH of less than about 2.

The invention will now be described by the following non-limiting examples.

### EXAMPLES

### Example 1

### Formulation

### Starting Material:

28 wt. % Hydrogen Peroxide
14 wt. % Acetic acid
1.5 wt. % Dequest®

1 wt. % Benzotriazole (or 2 wt. % SDS)
4 wt. % L-44
0.3 wt. % Phosphoric acid

### Final Product:

25 wt. % Hydrogen Peroxide (23 wt. %-26 wt. %)
10 wt. % Acetic acid
1.5 wt. % Dequest
1 wt. % benzotriazole (or 2 wt. % SDS)
4 wt. % L-44
0.3 wt. % Phosphoric acid

### Example 2

### Data Summary of Wassenburg PAA Bench Testing

All testing was performed at MRC (450 ppm) for 5 minutes at 40° C.

TABLE 1
Effectiveness of Wassenburg PAA SS was tested using a suspension
test against vegetative bacterium, Mycobacterium, and endospores.
An average of 1 × 10⁶ colony forming units (cfu)/ml of
bacterium was subjected to the germicide for 5 minutes of contact
time at 40° C. After the contact time, the samples were
neutralized and then assayed for survivors. All three suspension
tests achieved the EN required log reductions.

| | EN | | Pass/ | Average |
|---|---|---|---|---|
| Test Name | Standard | Organism | Fail | LOG₁₀ |
| Bacterial Suspension | 13727 | P. aeruginosa | Pass | 7.48 |
| | | S. aureus | Pass | 7.64 |
| | | E. hirae | Pass | 7.91 |
| Mycobactericidal | 14348 | M. terrae | Pass | 6.42 |
| Suspension | | M. avium | Pass | 6.22 |
| Sporicidal Suspension | 14347: 2005 | B. subtilis | Pass | 5.72 |

TABLE 2
Effectiveness of Wassenburg PAA SS was tested using a carrier
test against vegetative bacterium and Mycobacterium. An average of
1 × 10⁶ cfu/ml was dried onto glass carriers and subjected
to the germicide for 5 minutes at 40° C. After the contact
time, the carriers were then transferred to a neutralizer and
then assayed for survivors. The required log reduction for the
EN standards was achieved for both carrier tests.

| | EN | | Pass/ | Average |
|---|---|---|---|---|
| Test Name | Standard | Organism | Fail | LOG₁₀ |
| Bacterial Carrier | 14561: 2006 | P. aeruginosa | Pass | 7.15 |
| | | S. aureus | Pass | 7.15 |
| | | E. hirae | Pass | 7.98 |
| Tuberculocidal | 14563 | M. terrae | Pass | 5.78 |
| Carrier | | M. avium | Pass | 6.56 |

TABLE 3
Effectiveness of Wassenburg PAA SS was tested via simulated
use of an automated endoscope reprocessor (AER) and endoscopes
representative of those that are most difficult and/or critical to disinfect.
The endoscopes were inoculated with ~1 × 10⁷ cfu of
Mycobacterium terrae. After drying for one hour, the endoscopes
were exposed to a 5-minute disinfection cycle of the Wassenburg
Discover AER under worst case conditions for the germicide
and machine. The endoscopes were then assayed for surviving
cells. In all three studies, the required 5-log reduction
was achieved.

| | EN | | Pass/ | Average |
|---|---|---|---|---|
| Test Name | Standard | Device | Fail | LOG₁₀ |
| Simulated Use | ISO 15883 | Gastroscope | Pass | 7.18 |
| | | Colonoscope | Pass | 7.83 |
| | | Bronchoscope | Pass | 6.15 |

TABLE 4
This study was an in-use test of the Wassenburg Discover AER
in order to support a clinical evaluation report as required
by EU medical device guidance MEDDEV 2.7.1. Three colonoscopes
were pre-washed using the clinic's standard procedure before
being disinfected by the Wassenburg Discover AER disinfection
cycle under nominal conditions. The colonoscopes were placed
in the AER and a full disinfection cycle was performed. This
full cycle included a pre-wash, a rinse, 5-minute disinfection,
air purge and drain, followed by 2 rinse cycles. After the cycle,
the colonoscopes were assayed for any surviving microbes.

| | EN | | Pass/ | |
|---|---|---|---|---|
| Test Name | Standard | Device | Fail | Survivors |
| Confirmatory | MEDDEV | Colonoscope | Pass | 0 |
| Clinical In-Use | 2.7.1 | | | |

1. A composition comprising:
(a) hydrogen peroxide;
(b) at least one of an inorganic acid and an organic acid;
(c) chelator;
(d) anticorrosive agent; and
(e) surfactant.

2. The composition of claim 1, which is a liquid concentrate disinfectant.

3. The composition of claim 1, which is non-corrosive.

4. The composition of claim 1, which is non-toxic.

5. The composition of claim 1, having a long-term stability such that at about 1 atm and about 19° C., less than about 5 wt. % of each component independently degrades over about one year.

6. The composition of claim 1, having a long-term stability such that at about 1 atm and about 19° C., at least about 95 wt. % of each component is independently present after about one year.

7. The composition of claim 1, which is a one-part composition.

8. The composition of claim 1, which is essentially free of buffer.

9. The composition of claim 1, comprising less than about 0.1 wt. % buffer.

10. The composition of claim 1, wherein the hydrogen peroxide is 35% (w/w) in water, present in at least about 20 wt. % of the composition.

11. The composition of claim 1, wherein the hydrogen peroxide is about 35% (w/w) in water, present in about 20 wt. % to about 30 wt. % of the composition.

12. The composition of claim 1, wherein the organic acid comprises acetic acid.

13. The composition of claim 1, wherein the organic acid comprises glacial acetic acid.

14. The composition of claim 1, wherein the organic acid comprises acetic acid, present in at least about 5 wt. % of the composition.

15. The composition of claim 1, wherein the organic acid comprises acetic acid, present in about 9 wt. % to about 20 wt. % of the composition.

16. The composition of claim 1, wherein inorganic acid comprises phosphoric acid.

17. The composition of claim 1, wherein inorganic acid comprises phosphoric acid, ≧about 85% (w/w) in water.

18. The composition of claim 1, wherein the inorganic acid comprises phosphoric acid, comprising less than about 0.001 wt. % transition metals.

19. The composition of claim 1, wherein the inorganic acid comprises phosphoric acid and the organic acid comprises acetic acid.

20. The composition of claim 1, wherein the chelator effectively chelates transition metals.

21. The composition of claim 1, wherein the chelator comprises Dequest® 2010 (1-hydroxyethylidene-1,1,-diphosphonic acid, HEDP).

22. The composition of claim 1, wherein the chelator comprises Dequest® 2010 (1-hydroxyethylidene-1,1,-diphosphonic acid, HEDP), present in at least about 0.5 wt. % of the composition.

23. The composition of claim 1, wherein the chelator comprises Dequest® 2010 (1-hydroxyethylidene-1,1,-diphosphonic acid, HEDP), present in about 0.5 wt. % to about 3.0 wt. % of the composition.

24. The composition of claim 1, wherein the anticorrosive agent comprises an anionic surfactant.

25. The composition of claim 1, wherein the anticorrosive agent comprises at least one of benzotriazole and sodium dodecyl sulfate (SDS).

26. The composition of claim 1, wherein the anticorrosive agent comprises benzotriazole, present in at least about 0.25 wt. % of the composition.

27. The composition of claim 1, wherein the anticorrosive agent comprises benzotriazole, present in about 0.5 wt. % to about 2.0 wt. % of the composition.

28. The composition of claim 1, wherein the anticorrosive agent comprises sodium dodecyl sulfate (SDS), present in at least about 1.0 wt. % of the composition.

29. The composition of claim 1, wherein the anticorrosive agent comprises sodium dodecyl sulfate (SDS), present in about 1.0 wt. % to about 2.0 wt. % of the composition.

30. The composition of claim 1, wherein the surfactant comprises a non-ionic surfactant.

31. The composition of claim 1, wherein the surfactant comprises at least one of an anionic and cationic surfactant.

32. The composition of claim 1, wherein the surfactant comprises at least one of Pluronic® L44 surfactant Poloxamer 124 block copolymer and Pluronic 10R5 Reverse Triblock copolymer.

33. The composition of claim 1, wherein the surfactant comprises at least one of Pluronic® L44 surfactant Poloxamer 124 block copolymer and Pluronic 10R5 Reverse Triblock copolymer, present in at least about 2.0 wt. % of the composition, combined.

34. The composition of claim 1, wherein the surfactant comprises at least one of Pluronic® L44 surfactant Poloxamer 124 block copolymer and Pluronic 10R5 Reverse Triblock copolymer, present in about 2.0 wt. % to about 8 wt. % of the composition, combined.

35. The composition of claim 1, wherein the balance (q.s.) of the composition is water.

36. The composition of claim 1, which comprises less than about 0.001 wt. % heavy metals.

37. The composition of claim 1, which is a liquid concentrate disinfectant.

38. The composition of claim 1, formulated for use in a sprayable composition.

39. The composition of claim 1, formulated for use in contacting a surface of at least one of a hospital, physician's office, medical clinic, medical facility, dental office, dental facility, airport, school, pet store, zoo, children's day care, elderly nursing home, museum, movie theatre, athletic facility, sporting arena, gymnasium, rest room, bathroom, shopping center, amusement park, church, synagogue, mosque, temple, restaurant, food processing facility, food manufacturing facility, pharmaceutical company, hot-tub, sauna, and clean room.

40. The composition of claim 1, formulated for use in contacting at least one of metal, plastic, natural rubber, synthetic rubber, glass, stone, grout, fiberglass, wood, concrete, construction product, and building product.

41. The composition of claim 1, formulated for use in contacting at least one of medical equipment, medical device, surface in the medical industry, dental equipment, dental device, and surface in the dental industry.

42. A one part, liquid concentrate disinfectant comprising:
(a) about 20-30 wt. % hydrogen peroxide;
(b) about 5-20 wt. % of an inorganic acid, organic acid, or combination thereof;
(c) about 1-3 wt. % chelator;
(d) about 0.5-5 wt. % anticorrosive agent; and
(e) about 2-8 wt. % surfactant.

43. A one part, liquid concentrate disinfectant comprising:
(a) about 23-26 wt. % hydrogen peroxide, which is about 35% (w/w) in water;
(b) about 10 wt. % glacial acetic acid;
(c) about 1.5 wt. % Dequest® 2010 (1-hydroxyethylidene-1,1,-diphosphonic acid, HEDP);
(d) about 1.0 wt. % benzotriazole, or about 2 wt. % sodium dodecyl sulfate (SDS);
(e) about 4 wt. % Pluronic® L44 surfactant Poloxamer 124 block copolymer; and
(f) about 0.3 wt. % phosphoric acid, which is ≧about 85% (w/w) in water.

44. A kit comprising:
(a) an enclosed container comprising a removable closure,
(b) the composition of claim 1, located inside the enclosed container, and
(c) printed indicia located on the enclosed container.

45. The kit of claim 44, wherein the enclosed container is manufactured from high density polyethylene (HDPE).

46. The kit of claim 44, wherein the enclosed container is opaque.

47. The kit of claim 44, herein the printed indicia comprises instructions to avoid excessive heat, to avoid elevated temperatures, to avoid direct sunlight, or a combination thereof.

48. The kit of claim 44, wherein the enclosed container further comprises a head space.

49. The kit of claim 44, wherein the enclosed container further comprises a head space, wherein the head space comprises oxygen (O₂).

50. The kit of claim 44, wherein the enclosed container further comprises a head space, present in up to about 5% (v/v) of the enclosed container.

51. The kit of claim 44, wherein the removable closure of the enclosed container comprises a pressure valve, configured to release excessive gas from within the enclosed container.

52. The kit of claim 44, further comprising a liquid applicator comprising at least one of a spray bottle, wipe, cloth, sponge, non-woven fabric, and woven fabric.

53. A method of reducing the number of microbes located upon a substrate, the method comprising contacting the substrate with an effective amount of the composition of claim 1, for a sufficient period of time, effective to reduce the number of microbes located upon the substrate.

54. A method of killing or inhibiting a microorganism, the method comprising contacting the microorganism with an antimicrobially effective amount of the composition of claim 1, for a sufficient period of time, effective to kill or inhibit the microorganism.

55. A method of disinfecting a substrate, the method comprising contacting the substrate with an effective amount of the composition of claim 1, for a sufficient period of time, effective to disinfect the substrate.

56. The method of claim 53, wherein the microbe or microorganism comprises at least one of a virus, fungus, mold, slime mold, algae, yeast, mushroom and bacterium.

57. The method of claim 53, wherein at least about 6 logs of desired microorganism is inactivated in about 5 minutes, or less.

58. The method of claim 53, wherein at least about 6 logs of at least one of P. aeruginosa, S. aureus, E. hirae, M. terrae, M. intracellulare, and M. avium are inactivated in about 5 minutes, or less.

59. The method of claim 53, wherein at least about 6 logs of Mycobacterium terrae is inactivated in about 5 minutes, or less.

60. The method of claim 53, wherein about 1 wt. % of the composition is employed, in combination with about 99 wt. % carrier.

61. The method of claim 53, wherein about 1 wt. % of the composition is employed, in combination with about 99 wt. % water.

62. The method of claim 53, wherein the composition has a pH of less than about 3.

63. The method of claim 53, wherein the composition has a pH of less than about 2.
